(19) United States
(12) Patent Application Publication
(10) Pub. No.: US 2016/0356309 A1
(43) Pub. Date: Dec. 8, 2016

(54) ADJUSTABLE BALL-TYPE UNIVERSAL JOINT

(71) Applicant: COXON Precise Industrial Co., Ltd., Taoyuan City (TW)

(72) Inventor: Ming-Ta TSAI, Taoyuan City (TW)

(21) Appl. No.: 14/731,871

(22) Filed: Jun. 5, 2015

(51) Int. Cl. F16C 11/06

(52) U.S. Cl. CPC F16C 11/06

(57) ABSTRACT

The present invention discloses an adjustable ball-type universal joint, which is distinct from the conventional ball-type universal joint where the ball-type joint is hard to rotate stably or fixed securely. In the present invention, an elastic element is added to the bottom of the ball-type joint, providing elastic resilience to stabilize the rotation of the ball-type join and secure the fixation of the ball-type joint. Therefore, the present invention can improve performance and quality, save manpower and materials, reduce fabrication cost, and upgrade commercial competitiveness for the ball-type universal joint.

### BACKGROUND OF THE INVENTION

Field of the Invention

The present invention relates to a ball-type universal joint, particularly to an adjustable ball-type universal joint whose rotation can be modulated with elastic resilience.

Description of the Related Art

The level of living is increasing with social development and science-technology advancement, and the expectation to the quality of industrial and consumer products is growing higher and higher. In the conventional ball-type universal joint, the motion to a specified angle and the fixation at a specified position are controlled by the friction among the components thereof. Thereby, the conventional ball-type universal joint can connect the workpieces respectively aligned to different directions. However, the friction-based constraint method has some disadvantages: too large a friction force leads to difficulty of motion, and too small a friction force leads to failure of fixation.

Friction-based constraint is hard to verify and control. Friction would gradually decrease with abrasion. A friction-constraint device responds variably to the manipulations of different persons because the forces applied by them are hard to be completely identical. Even an identical friction-constraint device will respond variably to identical force because friction decreases with usage. Therefore, the performance of products using the conventional ball-type universal joint is imperfect and hard to meet the demands of consumers. Thus, the application of the conventional ball-type universal joint is limited. Accordingly, the Inventors develop an adjustable ball-type universal joint, which uses resilience of an elastic element to overcome the problems of difficult manipulation and unstable performance of the conventional ball-type universal joint.

### SUMMARY OF THE INVENTION

The primary objective of the present invention is to provide an adjustable ball-type universal joint, wherein an elastic element is added to a ball-type universal joint to effectively control the rotation and fix the position, whereby the ball-type universal joint can perform more reliably, wherefore the manpower and fabrication cost is reduced, and wherefore the quality and competitiveness of the products is promoted.

To achieve the abovementioned objective, the present invention proposes an adjustable ball-type universal joint, which comprises a body, a ball-type joint and an elastic element. The body has an assembly socket, and the ball-type joint and the elastic element are installed in the assembly socket. The elastic element is arranged below the bottom of the ball-type joint, providing and storing elastic resilience, and limiting the vertical displacement of the ball-type joint in the assembly socket. While intending to vary the angle of the ball-type joint, the user applies external force greater than the elastic resilience of the elastic element to press down the ball-type joint. Thus, the elastic element together with the ball-type joint descends. Then, the user applies external force to adjust the angle of the ball-type joint. After the ball-type joint acquires the intended angle, the user stops applying external. Hence, the elastic element releases the elastic resilience to move the ball-type joint upward to resume the ball-type joint to the original constrained state and preserve the acquired angle securely.

In the adjustable ball-type universal joint of the present invention, the elastic resilience of the elastic element is used to stabilize the rotation of the ball-type joint. As long as a force greater than the elastic resilience is applied to the ball-type joint, the ball-type joint can be rotated stably to a required angle. Once the force is removed, the elastic resilience restores the ball-type joint to the original constrained state with the acquired angle being fixed securely. The present invention uses the elastic resilience to effectively promote the performance in rotation and fixation of the ball-type joint and enable the user to manipulate the ball-type joint easily and confidently. Therefore, the present invention can increase the reliability of the products and raise the commercial value of the products.

Below, embodiments are described in detail to make easily understood the objectives, technical contents, characteristics and accomplishments of the present invention.

### BRIEF DESCRIPTION OF THE DRAWINGS

FIG. 1 is a perspective view schematically showing an adjustable ball-type universal joint according to one embodiment of the present invention;

FIG. 2 is a sectional view schematically showing an adjustable ball-type universal joint according to one embodiment of the present invention;

FIG. 3 is a planar exploded view schematically showing an adjustable ball-type universal joint according to one embodiment of the present invention;

FIG. 4 is an enlarged view schematically an elastic element of an adjustable ball-type universal joint according to one embodiment of the present invention;

FIGS. 5A-5C are diagrams sequentially showing the movements of an adjustable ball-type universal joint acted on by external force according to one embodiment of the present invention; and

FIG. 6 is a sectional view schematically showing an adjustable ball-type universal joint according to another embodiment of the present invention.

### DETAILED DESCRIPTION OF THE INVENTION

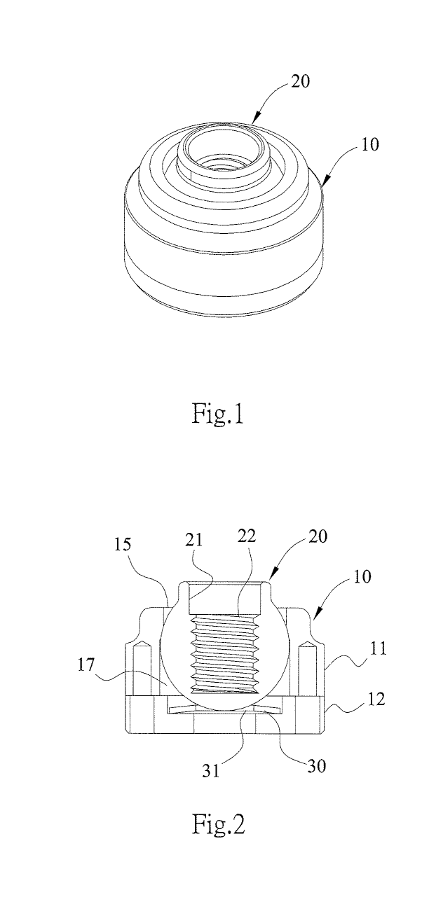

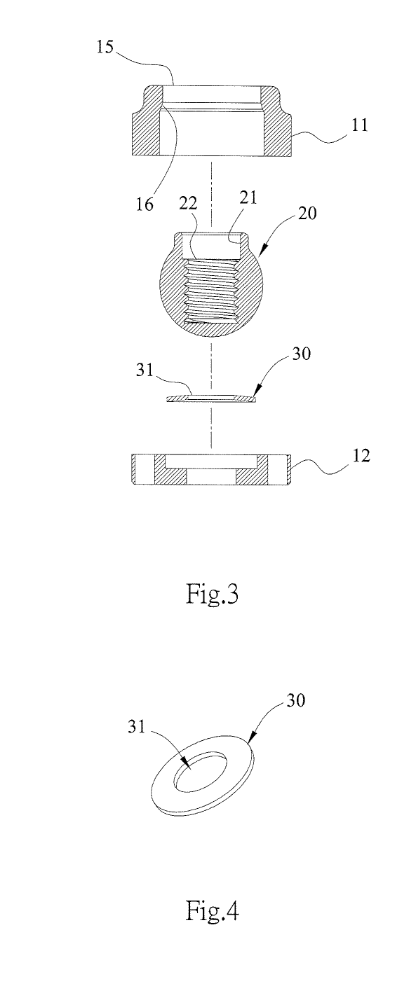

Refer to FIG. 1 and FIG. 2 respectively a perspective view and a sectional view schematically showing an adjustable ball-type universal joint according to one embodiment of the present invention. Also refer to FIG. 3 a planar exploded view schematically showing an adjustable ball-type universal joint according to one embodiment of the present invention.

In the embodiment shown in FIGS. 1-3, the adjustable ball-type universal joint of the present invention comprises a body 10, a ball-type joint 20 and an elastic element 30. The abovementioned components will be described in detail below.

The body 10 includes a seat 11 and a sleeve 12, which are hollow structures and assembled together by a plurality of fixing elements (such as screws). The fixing elements are not depicted in the drawings lest they interfere with the emphasis of the characteristics of the present invention. An assembly socket 17 is formed in the assemblage of the seat 11 and the sleeve 12, receiving the other components (such as the ball-type joint 20 and the elastic element 30). The top of the assembly socket 17 has a hole 15 open to the exterior. A pressing member 16 is formed below the hole 15 and near the hole 15, extended to the interior of the assembly socket 17 and slightly contracting inward, as shown in FIG. 3. The ball-type joint 20 is arranged inside the assembly socket 17 and above the elastic element 30. The top of the ball-type joint protrudes from the hole 15 and can be pressed down by external force. The interior of the ball-type joint 20 has a tube-like connection portion 21. The interior of the tube-like connection portion 21 has an inner thread 22, which is to be engaged with another component having an outer thread. In the embodiment shown in FIGS. 1-3, the elastic element 30 is a metallic elastic plate. As shown in FIG. 4, a positioning hole 31 is formed at the center of the elastic element 30, receiving and positioning the bottom of the ball-type joint 20. The elastic element 30 can store elastic resilience. The perimeter of the elastic element 30 is deflected downward and cooperates with the bottom of the assembly socket 17 to form a buffer space for accommodating the descending of the ball-type joint 20 and the deformation of the elastic element 30. The perimeter of the elastic element 30 can elastically support the bottom of the ball-type joint 20. Thus, the top and bottom of the ball-type joint 20 are respectively constrained fixedly by the pressing member 16 and the elastic element 30. In other words, the vertical displacement of the ball-type joint 20 is inhibited. Thereby, the ball-type joint 20 remains immobile.

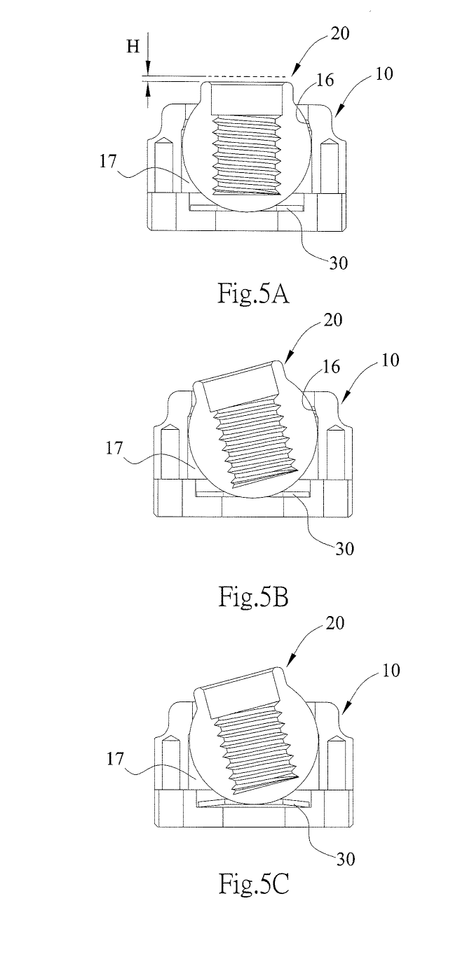

Refer to FIGS. 5A-5C diagrams sequentially showing the movements of an adjustable ball-type universal joint acted on by external force according to one embodiment of the present invention.

While intending to rotate the ball-type joint 20 for adjusting the angle thereof, the user applies an external force F to the ball-type joint 20. If the external force F is able to overwhelm the elastic resilience of the elastic element 30 (i.e. the compression force is greater than the elastic resilience), the ball-type joint 20 would press the elastic element 30 to descend along the assembly socket 17, as shown in FIG. 5A. At this time, the elastic element 30 is compressed to deform, and the ball-type joint 20 is displaced from the original position to have a height difference H with respect to the original position. Thus, the top of the ball-type joint 20 is slightly released from the constraint of the pressing member 16 of the assembly socket 17 and in a rotatable state. Next, as shown in FIG. 5B, the user applies the external force F to tilt or rotate the ball-type joint 20 toward the horizontal direction until the ball-type joint 20 reaches a specified angle θ, which is within an allowable range. While the ball-type joint 20 reaches the angle θ, the user no more applies the external force F and lets the elastic element 30 release elastic resilience to move the ball-type joint 20 upward to resume the ball-type joint 20 to the original constrained state and preserve the acquired angle θ securely, as shown in FIG. 5C. Thus is completed the orientation (rotation and fixation) of the ball-type joint 20.

In the adjustable ball-type universal joint disclosed in the abovementioned embodiments, the elastic element is made of a metallic material; the displacement and deformation of the structure of the elastic element is used to control the rotation of the ball-type joint and modulate the force of operating the rotation. However, the present invention does not limit that the elastic element must be made of a metallic material. In other embodiments, the elastic element is an elastic body made of a plastic material or a rubber material.

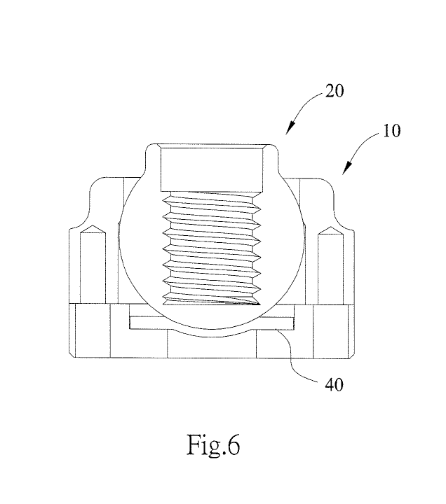

Refer to FIG. 6 a sectional view schematically showing an adjustable ball-type universal joint according to another embodiment of the present invention. In the embodiment shown in FIG. 6, the elastic element 40 is an elastic body made of a plastic material featuring abrasion resistance, toughness and elasticity. The external force-induced deformation of the structure of the plastic elastic element 40 can be used to control the rotation and positioning of the ball-type joint 20. The plastic elastic element 40 is different from the metallic elastic element 30 in that the elastic resilience of the plastic elastic element 40 controls the direction and angle of the rotation of the ball-type joint 20 in an interfering way. The greater the external force, the more intense the interference; the smaller the external force, the weaker the interference. Featuring lubricity and abrasion resistance, the plastic elastic element 40 has a longer service life in addition to the ability of controlling the direction and angle of the rotation of the ball-type joint 20.

In conclusion, the present invention proposes an adjustable ball-type universal joint to overcome the imperfect performance and quality of the conventional ball-type universal joint. The present invention uses the resilience of an elastic element to modulate the actions of rotation and angular adjustment of the ball-type joint. The elastic resilience of the elastic element acts on the ball-type joint to enable the user to rotate the ball-type more stably and precisely and fix the direction of the ball-type joint more securely. Thereby, the present invention can make the user operate the ball-type universal joint more easily and confidently and promote the performance and reliability of the ball-type universal joint effectively. Therefore, the present invention can save manpower and materials, reduce fabrication cost, and upgrade commercial competitiveness.

The embodiments described above are only to exemplify the present invention but not to limit the scope of the present invention. Any equivalent modification or variation according to the characteristic or spirit of the present invention is to be also included within the scope of the present invention.

What is claimed is:

1. An adjustable ball-type universal joint comprising
a body having an assembly socket;
a ball-type joint arranged inside said assembly socket; and
an elastic element arranged inside said assembly socket, storing elastic resilience, elastically supporting a bottom of said ball-type joint, and limiting vertical displacement of said ball-type joint in said assembly socket,
wherein an external force acts on said ball-type joint to overcome said elastic resilience and press down said ball-type joint to make said elastic element together with said ball-type joint descend along said assembly socket and rotate said ball-type joint to tilt to a specified angle, whereafter said external force is removed to let said elastic element release said elastic resilience to move said ball-type joint upward to resume said ball-type joint to an original constrained state and preserve said specified angle securely.

2. The adjustable ball-type universal joint according to claim 1, wherein said elastic element is an elastic plate.

3. The adjustable ball-type universal joint according to claim 2, wherein perimeter of said elastic plate is curved to a direction and cooperates with a bottom of said assembly socket to form a buffer space for accommodating deformation of said elastic plate being pressed down.

4. The adjustable ball-type universal joint according to claim 2, wherein said elastic element is a metallic circular elastic plate having a positioning hole at a center thereof for accommodating said ball-type joint.

5. The adjustable ball-type universal joint according to claim 1, wherein said elastic element is made of a plastic material or a rubber material.

6. The adjustable ball-type universal joint according to claim 1, wherein said ball-type joint has a tube-like connection portion thereinside, and wherein said tube-like connection portion has an inner thread thereinside, and wherein said inner thread is to be engaged with another component with an outer thread.

7. The adjustable ball-type universal joint according to claim 1, wherein said body has a hole interconnecting with said assembly socket, and wherein a top of said ball-type joint is protruded from said hole and acted on by said external force.

8. The adjustable ball-type universal joint according to claim 1, wherein an upper region of said assembly socket has a pressing member extending toward an interior of said assembly socket, and wherein a top and said bottom of said ball-type joint are respectively constrained by said pressing member and said elastic element, whereby vertical displacement of said ball-type joint in said assembly socket is limited.
